(19) United States
(12) Patent Application Publication
(10) Pub. No.: US 2013/0204670 A1
(43) Pub. Date: Aug. 8, 2013

(54) METHOD AND SYSTEM FOR AUTOMATED BUSINESS CASE TRACKING

(71) Applicants: Prasad A. Chodavarapu, Bangalore (IN); Subramaniam Turuvekere, Bangalore (IN)

(72) Inventors: Prasad A. Chodavarapu, Bangalore (IN); Subramaniam Turuvekere, Bangalore (IN)

(21) Appl. No.: 13/368,377

(22) Filed: Feb. 8, 2012

(51) Int. Cl. G06Q 10/06

(52) U.S. Cl. 705/7.36

(57) ABSTRACT

A method and system to provide automated tracking of a business case with respect to a targeted aspect of the business process, such as an enterprise IT initiative pertaining to a change in the enterprise IT applications for introduction of a new enterprise IT application. Elements of a business case definition may be incorporated in an enterprise IT application and/or, for a Business Process Management Application, in a business process model. A business case tracking engine may automatically measure benefit indicators to produce a real-time or near real-time display that shows how well the business case is realized in practice, and to identify when the business case is fulfilled or invalidated. Additional methods and systems are disclosed.

### TECHNICAL FIELD

The present application relates generally to the technical field of methods and systems for process management. An example embodiment relates to methods and systems to provide automated business case tracking.

### BACKGROUND

The implementation of a business process, an aspect of a business process, or a redesigned aspect of a business process may be motivated by potential benefits that may result from a newly implemented process, a newly implemented aspect of an existing process, or a redesigned aspect of the process.

When a business process is implemented or when a business process is reengineered in that an aspect of the business process is removed, added, or changed, it can be problematic to establish whether or not the process or process aspect implementation realizes expected benefits or assumptions that originally motivated the implementation or reengineering effort.

### BRIEF DESCRIPTION OF THE DRAWINGS

Some embodiments are illustrated by way of example and not limitation in the figures of the accompanying drawings. In the drawings, like reference numerals indicate like elements.

FIG. 1 is a high-level schematic diagram of a business case tracking system, in accordance with an example embodiment.

FIG. 2 is a schematic block diagram of an environment in which a a business case tracking system is provided, in accordance with another example embodiment.

FIG. 3 is a schematic block diagram of business case tracking application(s) forming part of the example embodiment of a business case tracking system.

FIG. 4 is a schematic diagram of a data structure of business process model information that may form part of a business case tracking system, according to an example embodiment.

FIGS. 5A-5D is a schematic view of a part of logical process model information forming part of business process model information in accordance with an example embodiment.

FIG. 6A is a schematic diagram illustrating operation of a business case tracking system, in accordance with an example embodiment.

FIG. 6B is a schematic diagram illustrating operation of a business case tracking system, in accordance with another example embodiment.

FIG. 7 is a high-level schematic flow chart of a method of automated business case tracking, in accordance with an example embodiment.

FIG. 8 is a schematic flow chart illustrating a more detailed example embodiment of a method of automated business case tracking.

FIG. 9 is a diagrammatic representation of a machine in the example form of a computer system within which a set of instructions for causing the machine to perform any one or more of the methodologies discussed herein may be executed.

### DETAILED DESCRIPTION

Example methods and systems to manage a business process and/or business process reengineering, and to track business case realization in an automated fashion are described. In the following description, for purposes of explanation, numerous specific details are set forth in order to provide a thorough understanding of example embodiments. It will be evident, however, to one skilled in the art that the many embodiments may be practiced without these specific details.

According to example embodiment, a method to calculate and track fulfillment or realization of benefits and/or assumptions associated with a business process or aspect thereof is provided. The method may include dynamically measuring one or more benefit indicators in an automated fashion, accessing a business case definition that includes one or more quantified expectations with respect to the relevant aspect of the business process, and generating a progress report that indicates the one or more measured benefit indicators relative to one or more corresponding quantified expectations. A system to implement such an example method may include a business case tracking module to measure the benefit indicators in or near real-time, and a progress report generator to generate the progress report based on the measured benefit indicators and based on predefined business case criteria or quantified expectations. By “near real-time” is meant measurement that lags ruled occurrence of a′ corresponding events by a time difference which is no greater than an average end-to-end completion time for the process or process aspect.

In some embodiments, the method may pertain particularly to automated tracking of business case realization for a redesigned aspect of the business process. In such a case, the method comprises, during performance of the business process, dynamically measuring benefit indicators in an automated fashion, the one or more benefit indicators being associated with the redesigned aspect of the business process; accessing a business case definition that includes one or more quantified expectations with respect to implementation of the redesigned aspect; and generating a progress report that indicates the one or more measured benefit indicators relative to one or more corresponding quantified expectations associated with the redesigned aspect.

Although the example embodiment further described below is for business case tracking of a redesigned aspect of the business process, it should be noted that other embodiments may provide similar functionality with respect to an initial process design and implementation, or to design/redesign and implementation of not only an aspect of the business process, but of the business process as a whole.

When, in the present example embodiment relating to business process redesign, modification or redesign of an existing business process is contemplated, an owner of the business process may consider a business case for implementing a modification to or redesign of a particular aspect of the business process. The business case may include one or more expectations associated with implementing the redesigned aspect, and may comprise reasons for implementing the business process redesign. Such reasons may include business benefits that are expected to result from implementation of the redesigned aspect, such as, for example improved service level agreement (SLA) compliance, reduced cost (measured in man hours, consumed resources, currency, etc), improved completion time of a process activity or sub-process, improved customer satisfaction, improved employee job satisfaction, or the like. The expectations associated with the redesigned implementation may instead or in addition include assumptions on which a decision to implement the redesigned aspect might be based, such as, e.g., that the redesigned aspect will result in a certain percentage improvement in a particular performance measure of the business process. Such expectations upon which a decision to implement the redesigned aspect might be based may be quantified and may defined by an operator at design-time, and may be associated with particular benefit indicators related to realization or satisfaction of the redesign expectations. The term “benefit indicators” as used here in therefore includes assumption indicators and/or expectation indicators. The system may include a business case database in which the quantified expectations or business case criteria are stored.

Thereafter, realization of the business case may be tracked by dynamically monitoring the redesigned aspect of the business process with respect to the benefit indicators, so that a business owner may assess proactively with reference to the report whether or not the quantified expectations associated with the redesigned aspect are being realized or satisfied. The degree to which the quantified expectations have been reached may also be reported. The business owner may thus be provided with dynamic tracking of the business case for a particular business process redesign or change. Measuring the benefit indicators may comprise receiving at the business case tracking module performance data and/or event alerts with respect to operational cases or instances of the business process.

By dynamic measurement is meant that the measurement is performed on an ongoing basis during performance of the business process. The measurement may thus occur at or near real-time, although there may in some instances be a lag between the occurrence of certain events during the performance of the business process and measurement and/or report thereof.

The redesigned aspect of the business process may comprise any one of a number of constituent parts of the business process. The redesigned aspect may thus comprise a single added or modified process activity, a modified or added series or sequence of process activities, a modified or added sub process, or the like. In instances where automated business case tracking is performed not with respect to a redesigned aspect of the business process, but for the business process or a separate aspect thereof, the methodologies described in this example embodiment may be applied in a similar manner to a targeted aspect that may, for example, comprise a single process activity, a series or sequence of activities, a sub-process, a complete business process, or the like. The term “process” as used herein comprises a series of activities to produce a product or to perform a service. “Process” or an aspect thereof is to be interpreted broadly as including a process group, a sub-process, or any collection of processes.

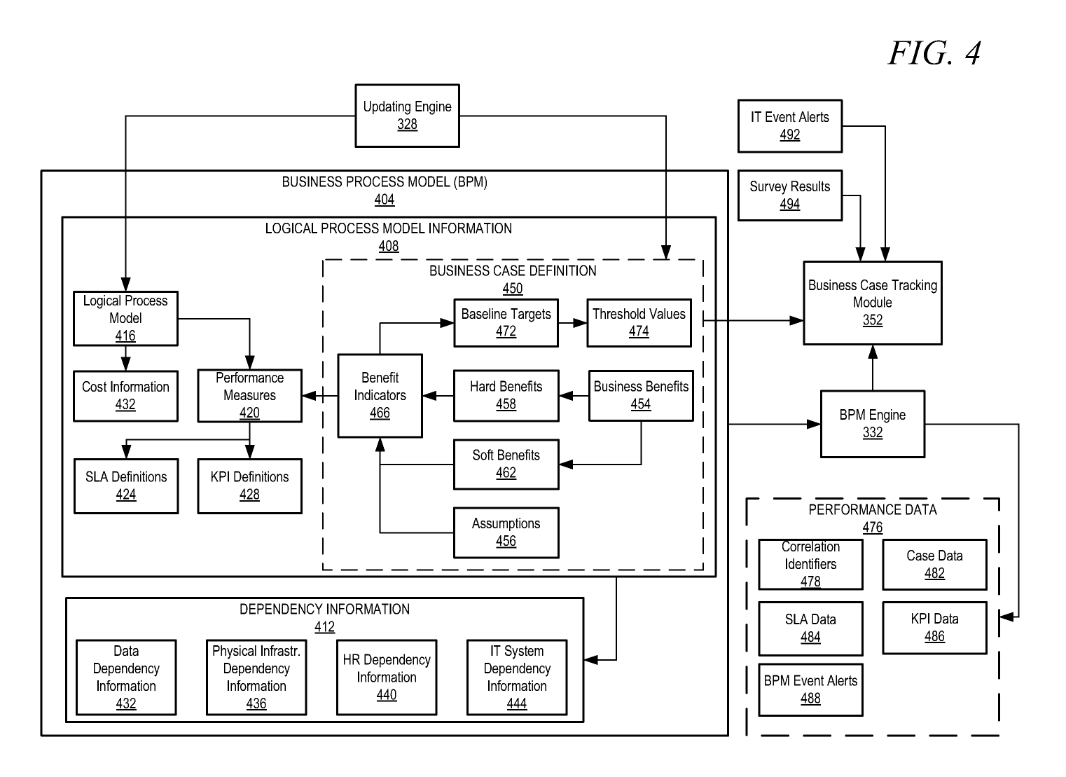

The targeted aspect for which a business case may be defined and automatically tracked may include an enterprise IT initiative comprising a change in enterprise IT applications for the introduction of a new enterprise application. Business case tracking as described herein may therefore be employed with respect to changes to existing applications, or introduction of new applications, in an enterprise IT system that performs at least part of the business process, even though there may in some instances be no change to the particular operations or sequence of operations comprising the process. Differently described with reference to an embodiment where the process is modeled in a business process model and managed by a business process management application (and as can best be understood with reference to FIG. 4 below), the targeted aspect of the business process may comprise introduction of or change to an element of dependency information (e.g. IT system dependency information), without necessarily being accompanied by introduction of or change to any elements of logical process model information. Any combination of operationalization system elements and logical process elements may, however, be targeted for automated business case tracking based on an associated business case definition.

By a quantified expectation is meant a user-specified value for a particular performance measure that defines a benefit, expectation, or assumption forming part of the business case for implementation of the targeted aspect to which the relevant business case pertains. Each benefit indicator may thus be with respect to at least one performance measure that is associated with the one or more quantified expectations. For example, if one of the quantified expectations or benefits is a 20% increase in SLA compliance for a particular process activity, an associated benefit indicator may comprise a real-time SLA compliance percentage for the relevant activity.

Measuring the one or more benefit indicators may comprise receiving event alerts from one or more information technology (IT) system elements that form part of an IT infrastructure by which at least part of the business process is performed, each event alert indicating the occurrence of an event that is associated with a particular benefit indicator. IT system applications may for example be configured automatically to generate and send event alerts to the business case tracking module or a benefits inference engine responsive to the occurrence of predefined events. Process applications may to this end be provided with respective event reporting modules to automatically record the occurrence of predefined events, and to automatically send corresponding event alerts to the business case tracking module. For example, in an instance where one of the quantified expectations or expected benefit of a process aspect redesign is a quantified reduction in the frequency of occurrence of a particular type of incident, a corresponding benefit indicator may be the frequency of occurrence of such incidents relative to a total number of cases or instances processed. A computer application responsible for executing the associated activity may in such cases be configured automatically to communicate the occurrence of incidents to a business case tracking engine on an ongoing basis. In some embodiments, each event or incident results in the generation and transmission of a corresponding event alert, while in other embodiments, some event alerts may report the occurrence of events in batches.

Measuring the one or more benefit indicators may in such cases compromise capturing a sample of event alerts. In some embodiments, the benefit indicators may be measured continuously. Instead, the method may comprise continually or intermittently measuring the benefit indicators, for example by sampling information received by the business case tracking engine with respect to the benefit indicators. Such sampling may be time-based, in that event alerts and other information received by the business case tracking engine within a defined sample window may be considered. Instead, or in addition, the sampling may be event-based, so that, for example, a sample of event alerts received by the business case tracking engine may be taken without considering all event alerts received within a sample window. The sampling of event alerts may thus comprise taking a random sample from a number of event alerts received within a particular time period.

In some embodiments, measuring the one or more benefit indicators may comprise receiving performance data relevant to the one or more benefit indicators from a business process management engine (BPM engine) that correlates performance of current instances of the business process with a business process model that defines a series of activities comprising the business process. In other embodiments, however, automated business case tracking may be provided without the use of a BPM engine to correlate real-world performance of instances of the process to a predefined business process model. In such cases, dynamic measurement of the benefit indicators may be based on event alerts generated by IT system elements.

In example embodiments that include a BPM engine, the business process model may, for example, comprise a logical process model that defines the activities of the business process and the order or sequence in which the activities are to be performed. The business process model may further comprise dependency information that defines dependency of respective activities on associated IT system elements, human resource elements, and the like. The business process model may also include failure definitions or performance measures such as key performance indicators (KPIs), SLAs, and the like. The BPM engine may be configured to monitor and/or administer execution of respective instances or cases of the business process with reference to the business process model. The BPM engine may thus provide the business case tracking module with at or near real-time performance data with respect to multiple process instances. The performance data may include case data with respect to individual process instances, for example reporting completion time of particular activities or sub-processes. The performance data may instead, or in addition, include SLA data indicative of SLA adherence or violation with respect to the business process or part thereof. In some examples, the BPM engine includes an event alert generator to transmit performance data in the form of event alerts with respect to occurrence of predefined events. For example, the BPM engine may be configured to send to the business case tracking engine event alerts responsive to the occurrence of a predefined event, such as violation of an SLA associated with the targeted aspect of the business process, or responsive to a performance measure associated with the targeted aspect's exceeding a predefined threshold value.

Event alerts may thus be generated by the BPM engine and/or by IT system elements supporting the business process. Such IT system elements and the BPM engine may be configured to publish the event alerts in a predetermined format or schema.

The method may further comprise defining the one or more quantified expectations and/or the one or more benefit indicators in the business process model. The method may thus provide for an extension to a standard business process model to include a business case definition. The business case definition within the business process model may include one or more business goal or quantified expectations. The business case definition may also include particular KPIs or benefit indicators which are to be monitored in operation by the BPM engine. Such an augmented business process model may define tangible or hard benefits associated with the particular aspect of the business process model to which the relevant business case pertains (such as reduced receivables, reduced SLA violation, etc.), and may also define intangible or soft benefits associated with the targeted aspect (e.g., improved employee retention due to improved working environment). The business process model may further include baseline targets for respective benefit indicators. In one embodiment, the above-mentioned extended features of the business process model relating to the business case definition may be included in the business process model in process standard notation. The methods and systems disclosed herein therefore includes an extension or augmentation of existing business process models to include in the business process model a structured business case definition to facilitate business case tracking of one or more targeted aspects of the business process.

In other example embodiments in which the business process is not managed by a business process management application, elements of the business case may be incorporated in an enterprise IT application.

The method may further include providing a business case user interface, receiving via the business case user interface user input with respect to quantified expectations and/or benefit indicators, and automatically updating the business case definition to include the quantified expectations and/or benefit indicators provided by the user. In example embodiments where the method is implemented based at least in part on a defined business process model, a method may include automatically updating the business process model to include the quantified expectations and/or benefit indicators provided by the user. The business case user interface may in some example embodiments provide a redesign user interface to facilitate redesign of a particular aspect of the business process model, and to automatically update the business process model and the associated business case definition.

The system may thus include a benefits capture system or business case capture system to receive user definitions of business case criteria via direct data input, and may further include an updating engine to automatically update other elements of the business case tracking system, to effect business case tracking based on the business case criteria entered by the user via the business case user interface. The updating engine may, for example, include a process model updating engine to automatically update the process model so that it includes a business case definition based on the business case criteria provided by the user. The business case definition may be included in the business process model in the native coding format of the business process model, for example being in process standard notation such as business process model and notation (BPMN). In such embodiments, the user does not necessarily explicitly modify the business process model by editing the process standard notation in which the business process model is defined. Instead, the user may effect inclusion of the business case definition in the business process model which is to be monitored by the BPM engine by providing business case criteria to the process model updating engine via the business case user interface.

The method may also comprise receiving user input with respect to defining a target value for a particular benefit indicator, a corresponding quantified expectation being realized when a measured value of the particular benefit indicator meets or is within a predefined range of divergence from the associated target value. The business case definition may thus include various baseline targets for respective performance indicators.

Measuring of the benefit indicators may include receiving results of feedback surveys that indicate a performance measure associated with one of the benefit indicators. Intangible or soft benefits may thus be measured by the completion and collection of feedback surveys direct at the associated performance measures. For example, if one of the quantified expectations or business goals is to improve customer satisfaction or employee satisfaction, the measurement of the benefit indicators may comprise collection of information stemming from the completion of corresponding customer feedback surveys or employee feedback surveys.

Generating the progress report may comprise generating a display on which a current status of multiple benefit indicators are shown relative to corresponding quantified expectations. A business case dashboard may thus for example be generated, in which progress of multiple key performance indicators related to a modified or targeted aspect of the business process is displayed relative to user-defined baseline targets or business goals defined. Such a dashboard may include a visual display that shows, for example: variance between respective expected benefits and actualized benefits associated with the business process aspect; baseline targets for particular benefit indicators compared to operational values for those benefit indicators; a timeline or progress history for soft benefits realization (e.g. feedback survey results); and a timeline or progress history for hard benefits realization (e.g. SLA compliance improvement, cost reduction, etc.).

The method may further comprise automatically generating a business case alert responsive to the occurrence of predefined criteria with respect to correlation between a particular benefit indicator and an associated quantified expectation. The predefined criteria may be user-specified to cause generation of a business case alert when a particular business goal or assumption is realized, when a particular business goal or assumption is consistently missed, or when the operational measured benefit indicator diverges beyond a threshold value from an associated business goal or target. When a particular pre-identified KPI thus, for example, consistently meets threshold values associated with the corresponding quantified expectation, a business case alert or report may automatically be generated and transmitted to the business owner to inform the business owner of satisfaction of at least the relevant aspects of the business case. A business case alert may likewise be generated automatically when process goals are consistently not met beyond a predefined threshold. To this end, the business case definition may include various threshold values that serve as criteria for the generation of business case alerts.

A business case alert may instead or in addition be generated responsive to fulfillment, completion, and/or invalidation of the business case according to the associated business case definition. A business case may be considered to be fulfilled when all of the benefits (or a predefined threshold number of benefits) are realized, for example within a specific time period. A business case may also be considered completed or invalidated when all the assumptions listed in the business case (or a predefined threshold number of assumptions) are invalidated.

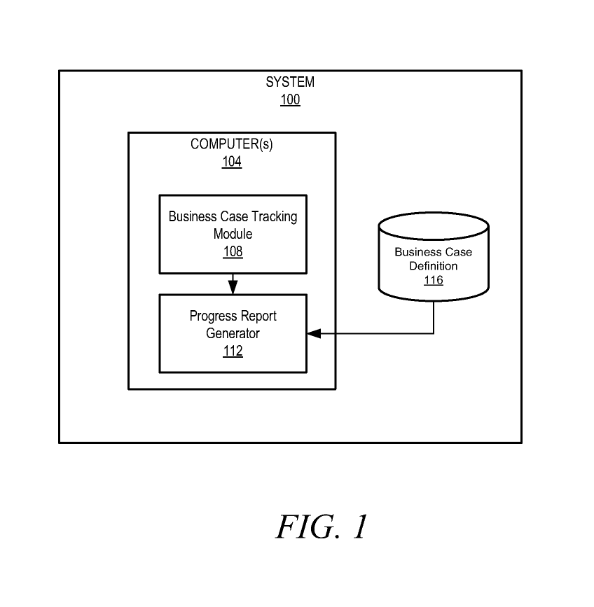

FIG. 1 is a high-level entity relationship diagram of an example configuration of a business case tracking system 100. The system 100 may include a computer 104 that comprises a business case tracking module 108 to dynamically measure a number of benefit indicators of a business process during performance of the business process, in an automated fashion. The performance indicators may be associated with a targeted aspect of the business process such as, for example a redesigned aspect of the business process. The system 100 may further include a progress report generator 112 that is configured to generate a progress report with respect to business case realization. The progress report generator 112 may be configured to access a structured business case definition 116 stored on one or more memories or databases. The business case definition 116 may include quantified expectations with respect to the targeted aspect of the business process (or for the process as a whole, in instances where the business case definition is with respect to the relevant process in its entirety). The business case definition 116 may also define the benefit indicators and may map relationships between the benefit indicators and the quantified expectations. The progress report may thus be generated by the progress report generator 112 based in part on the benefit indicators as measured by the business case tracking module 108, and based in part on the quantified expectations for the business case retrieved from the business case database 116.

It is to be noted that although the system 100 illustrated with reference to FIG. 1 shows, for ease of illustration, a single computer 104 and a single business case database 116, the elements of the system 100 may, in other embodiments be provided by any number of cooperating system elements, such as processors, computers, modules, and memories, that may be geographically dispersed.

### Environment Architecture

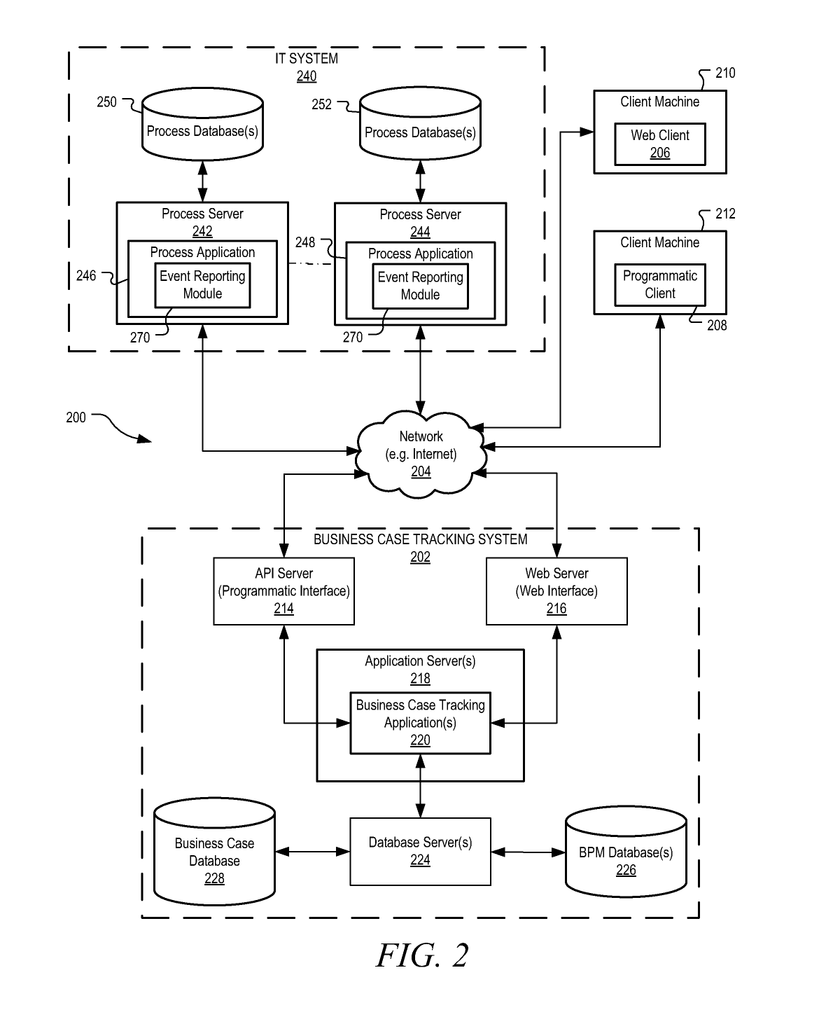

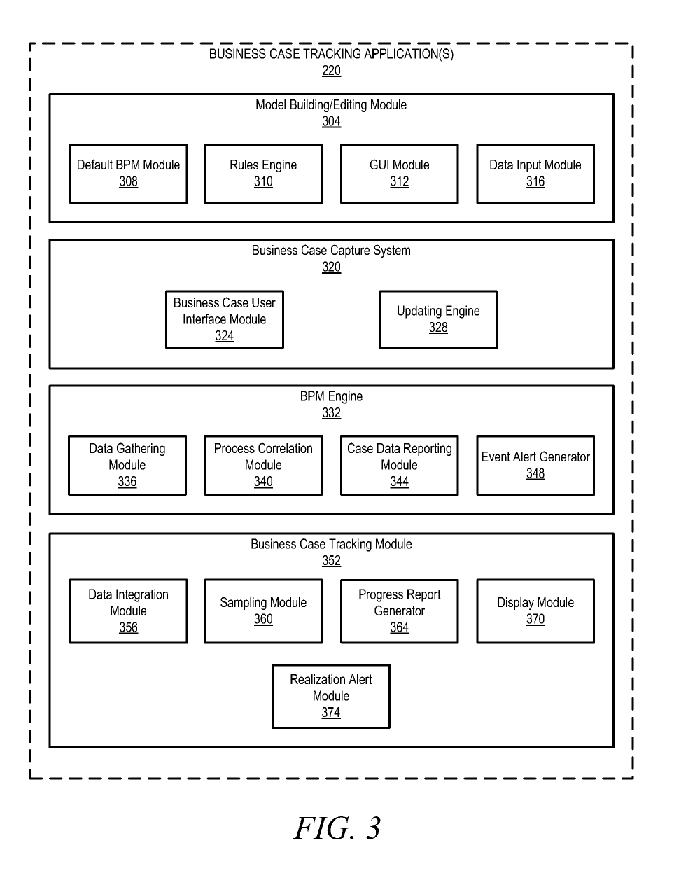

FIG. 2 is a network diagram depicting an example environment architecture within which another example embodiment of a business case tracking system 200 may be employed. It is to be appreciated that the example environment architecture illustrated with reference to FIGS. 2 and 3 is only one of many possible configurations for employing the methodologies disclosed herein. A business case tracking system 202 in this example embodiment provides server-side functionality, via a network 204 (e.g., the Internet, a Wide Area Network (WAN), or a Local Area Network (LAN), to one or more clients. FIG. 2 illustrates, for example, a web client 206 (e.g., a browser, such as the Internet Explorer browser developed by Microsoft Corporation of Redmond, Wash. State), and a programmatic client 208 executing on respective client machines 210 and 212.

An Application Program Interface (API) server 214 and a web server 216 are coupled to, and provide programmatic and web interfaces respectively to, one or more application servers 218. The application servers 218 host one or more business process model applications (BPM applications) 220 (see FIG. 3). The application server(s) 218 are, in turn, shown to be coupled to one or more database server(s) 224 that facilitate access to one or more database(s). The business case tracking system 202 may include BPM database(s) 226 that stores, e.g., information with respect to business process model information, operationalization data of the business process, case data of current instances of the business process, and business case information. As noted above, some example embodiments function without a defined business process model, and in such instances, a system similar to that of FIG. 2 may have no BPM database(s) 226.

In the example embodiment of FIG. 2, the BPM database(s) 226 includes a business case database 228 that includes business case definition information that defines one or more quantified expectations or benefits associated with a business case related to a targeted aspect of the business process, in this example being a redesigned aspect of the business process. Although the business case database 228 is shown in FIG. 2 as being separate from the BPM database(s) 226, a business case definition that forms part of business case information stored in the business case database 228 may be included in business process model information stored in the BPM database(s) 226 (see for example FIG. 4). This disclosure thus includes an extension to or an expansion of a business process model to include structured information that provides a business case definition for one or more aspects of the business process, as described in more detail below. An example architecture and/or interaction of the information stored in the database(s) 226, 228 is described in further detail below with reference to FIG. 4.

The system 202 is also in communication with an enterprise IT system 240 that supports a business process of which one or more targeted aspects may be tracked by the business case tracking application(s) 220. The business case tracking application(s) 220 may be in communication with components of the IT system 240, in particular being in communication with a number of process servers 242, 244 forming part of the IT infrastructure of the IT system 240. Each of the process servers 242, 244 supports one or more enterprise IT applications in the example form of process applications 246, 248, each process application 246, 248 providing functionalities employed in the performance of an associated activity or process supported by the IT system 240. Each process server 242, 244 may be in communication with one or more associated memories or database(s) 250, 252, to read and/or write associated process data to the respective process datastore(s) 250, 252.

For example, process application 246 may be an accounting application, the process data in the associated process datastore(s) 250 comprising client account information, while process server 244 may be a case management application, the process data in the associated process datastore(s) 252 comprising records of respective cases processed by the IT system 240. It will be appreciated that the IT system 240 may typically comprise a greater number of process servers 242, 244 and process datastores 250, 252, but FIG. 2 shows only two such process servers 242, 244, for ease of description. It is further to be appreciated that communication and interfacing between respective process servers 242, 244 may occur via the network 204, while some of the process servers 242, 244 may be in direct communication. It is further to be noted that although communication between the business case tracking application(s) 220 and the IT system 240 in this example embodiment comprises communication with the process servers 242, 244, business case tracking may in other example embodiments be performed with respect to any suitable IT system element by which process activities or operations are performed.

The process application(s) 246, 248 may further be provided with respective event reporting modules 270 to automatically record the occurrence of specific predefined events, and to automatically send corresponding event alerts to the business case tracking system 202. Each event reporting module 270 may thus be arranged or programmed to send event alerts responsive to occurrence of events associated with the process activity or operation of that is performed by the process application 246, 248 in which he is resident. For example, if the process application 246 is a requisitioning application, the associated event reporting module 270 may send event alerts responsive to submission, of defective requisition requests.

The business case tracking application(s) 220 may provide a number of functions and services to users that access the business case tracking system 202, including the provision of the process management, process redesign management and business case tracking functionality. Respective modules for providing these functionalities are discussed in further detail with reference to FIG. 3 below. While all of the functional modules, and therefore all of the business case tracking application(s) 220 are shown in FIG. 3 to form part of the business case tracking system 202, it will be appreciated that, in some embodiments, some of the functional modules or process model applications may form part of systems that are separate and distinct from the business case tracking system 202. Further, while the system 200 shown in FIG. 2 employs a client-server architecture, the example embodiments are of course not limited to such an architecture, and could equally well find application in, for example, a distributed or peer-to-peer architecture system. The business case tracking application(s) 220 could also be implemented as standalone software programs, which do not necessarily have networking capabilities.

In an instance that employs the architecture illustrated in FIG. 2, the web client 206 accesses the business case tracking application(s) 220 via the web interface supported by the web server 216. Similarly, the programmatic client 208 accesses the various services and functions provided by the business case tracking application(s) 220 via the programmatic interface provided by the API server 214.

### BPM Application(s)

FIG. 3 is a block diagram illustrating multiple functional modules of the business case tracking application(s) 220 of business case tracking system 202. Although the example modules are illustrated as forming part of a single application, it will be appreciated that the modules may be provided by a plurality of applications The modules of the application(s) 220 may be hosted on dedicated or shared server machines (not shown) that are communicatively coupled to enable communications between server machines. The modules themselves are communicatively coupled (e.g., via appropriate interfaces) to each other and to various data sources, so as to allow information to be passed between the modules or so as to allow the modules to share and access common data. The modules of the application(s) 220 may furthermore access the one or more databases 226, 228 via the database servers 224.

The business case tracking system 202 may provide a number of modules whereby a user may for example build or define a business process model(s), redefine the business process model, monitor execution of activities forming part of the business process, define a business case for one or more aspects of the business process model (including redesign of selected aspects of the business process), and automatically track realization of the business case.

A model building/editing module 304 may be provided to enable a user or administrator to define an enterprise-specific business process model, either by editing, adapting, or building on a selected default enterprise model, or by building a business process model from scratch. To this end, the model building/editing module 304 is shown to include at least one default BPM module 308 to provide default business process models (BPM) which are to serve as bases for a user to define a business process model specific to a particular process. The default BPMs may be predefined by a supplier of the business case tracking application(s) 220 and are in respect to generic business processes relating to a variety of types of businesses or types of business activities. A user may thus, as a starting point for defining an enterprise-specific BPM, select one or more default process models which most closely approximate the business processes performed by the IT system 240. The default process model module 308 may typically provide default logical process models indicating a series of activities, without specific operationalization information indicating particular process elements or support elements on which the activities are dependent.

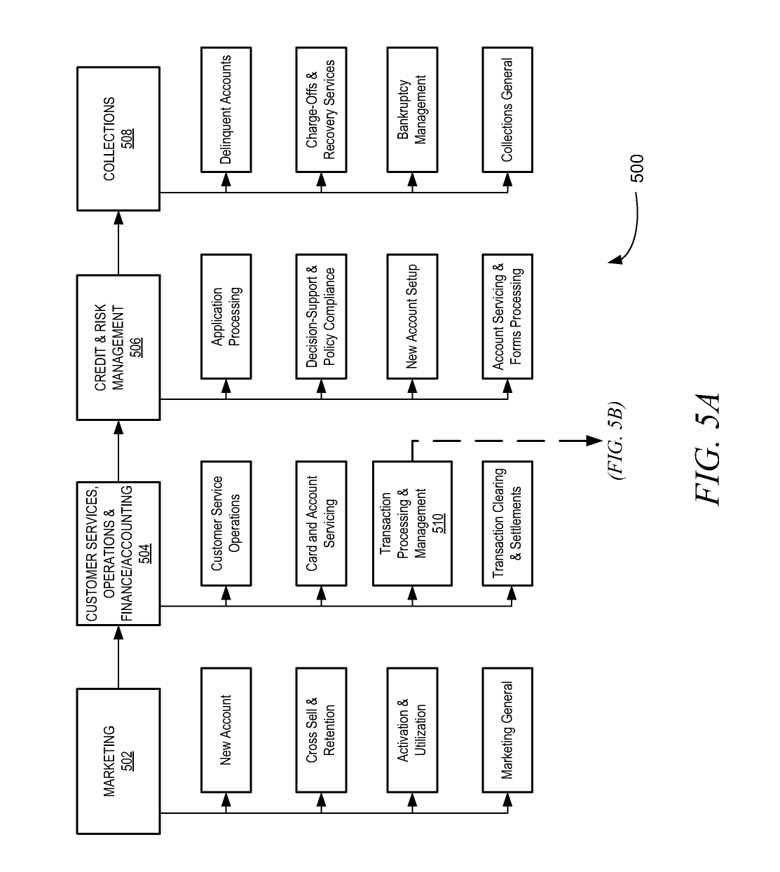

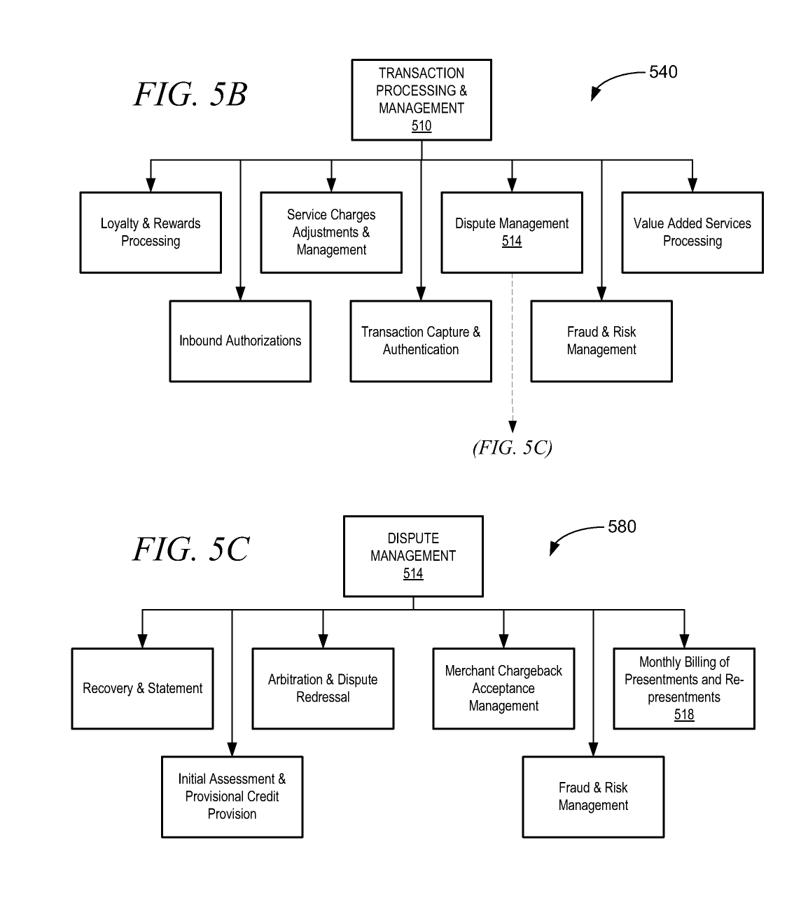

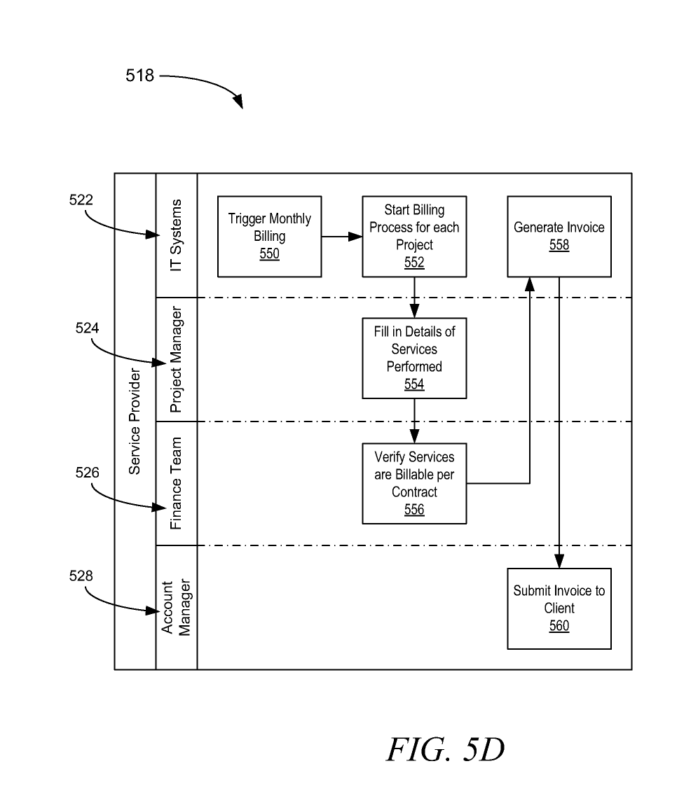

The model building/editing module 304 also enables the editing of the BPM in response to changes in the business process, for example if the user wishes to redesign or reengineer the BPM. An example BPM is described in greater detail with reference to FIGS. 4-5 below.

A graphic user interface (GUI) module 312 is provided to generate and manage an interactive GUI to display various aspects of the process model, and to permit user management of the BPM. In instances where all the processes of the relevant business process are defined in a BPM (e.g. instances where the BPM is an enterprise model), it is typically not possible to display a representation of all of the processes and/or an entire business architecture in a single view, and the GUI will allow user selection of different levels or layers of the enterprise model for viewing. Such drill-down functionality is described in greater detail below with reference to FIG. 5.

A data input module 316 provides functionality to permit the input of data for use in process modeling and predictive analysis. Information about scheduled downtime for the process applications 246, 248 and/or scheduled downtime for IT infrastructure elements may, for example, be obtained via the data input module 316. Similarly, in an example, embodiment human resource scheduling information, such as information about personnel availability, e.g. holiday calendars, may also be entered into the business case tracking system 202. The data input module 316 may be configured for manual input of this information, and may instead or in addition provide for automatic acquisition of scheduling data from other databases. For example, personnel unavailability data may automatically be obtained from a Human Resources database (not shown) forming part of the IT system 240.

A rules engine 310 may be provided to permit the definition of performance measures or metrics by which performance of business processes is to be measured. A user may thus provide, via the rules engine 310, performance measures that may include failure definitions that specify what constitutes failure of a particular business process. In an example embodiment, the business process model may include service-level agreements (SLAs) which specify, in measurable terms, contractual service commitments describing the minimum performance criteria an associated process is required to meet. Failure to comply with the requirements of a particular SLA may be specified as constituting failure of the associated process. The performance measures may further include the definition of performance indicators, such as key performance indicators (KPIs), in relation to respective processes or process activities. Such performance indicators may serve to provide quantifiable performance measurement of an associated process or process activity. KPIs may, for example, measure the cost or completion time of particular processes and/or activities.

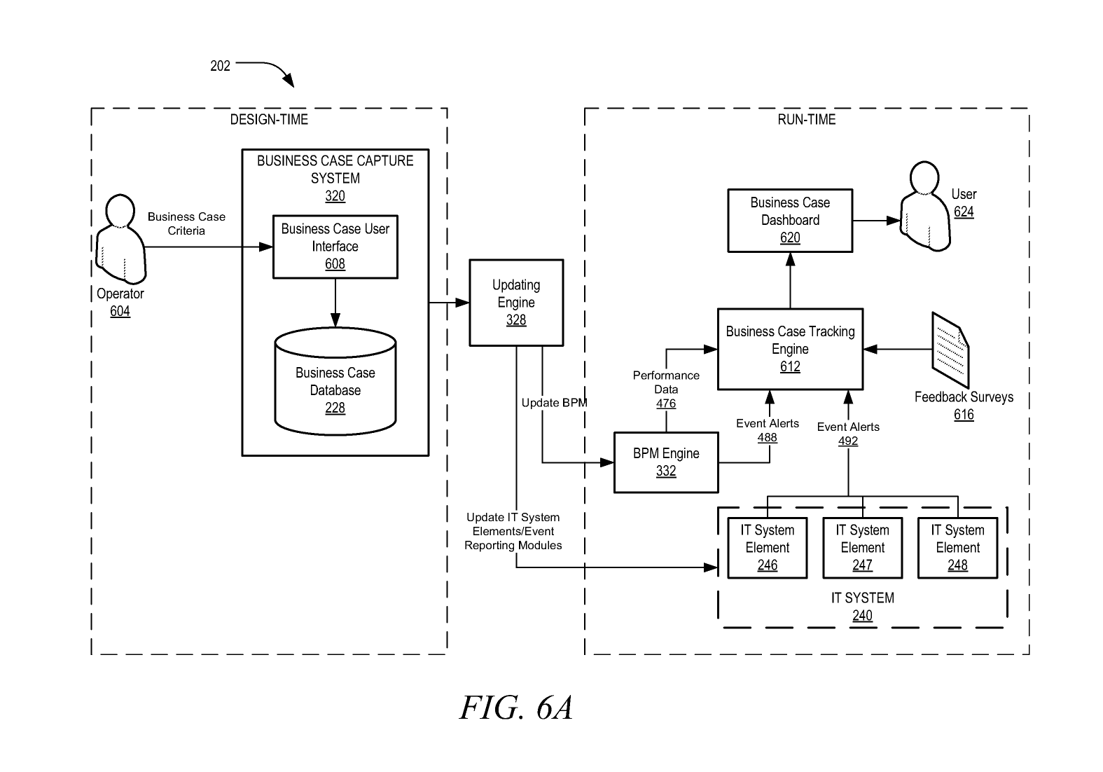

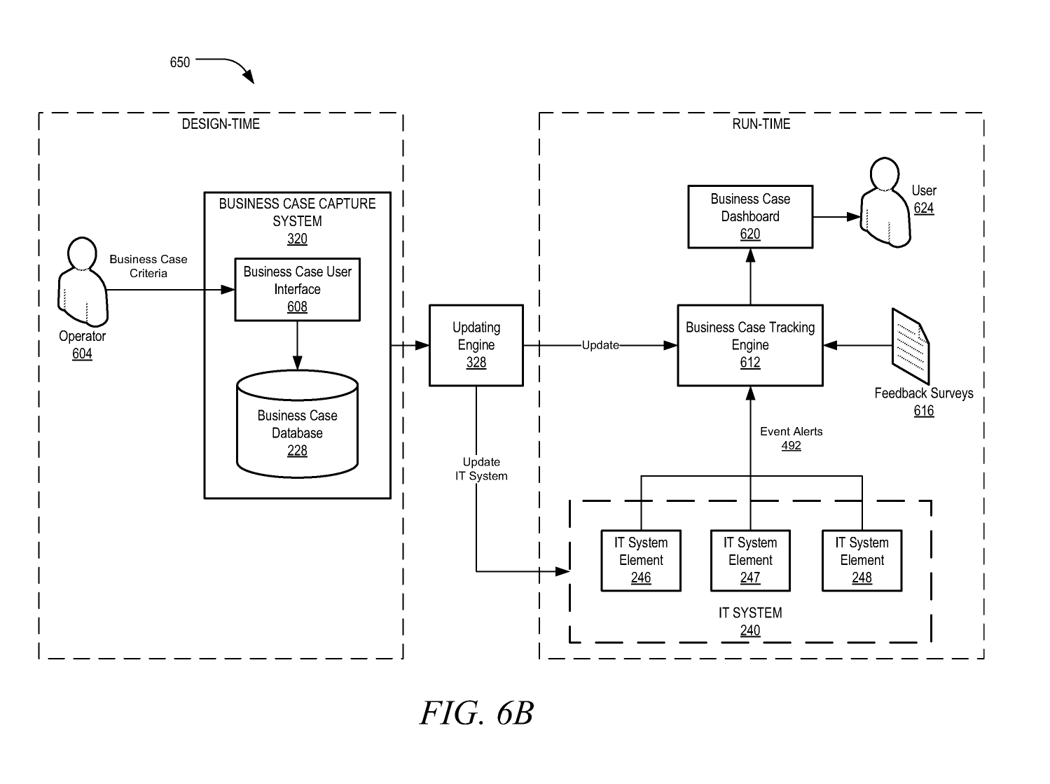

The business case tracking application(s) 220 may further include a business case capture system 320 to capture user input with respect to a business case for one or more aspects of the business process model, and/or for reengineering an aspect of the business process model. The business case capture system 320 may thus include a business case user interface module 324 to generate and manage a business case user interface (see for example FIGS. 6A-6B) through which a user may input business case criteria such as quantified expectations associated with a targeted aspect of the business process, such as a redesigned aspect of the business process in instances where business case realization for process redesign is to be tracked. In such instances, the business case user interface module 324 therefore provides a redesign user interface module. The quantified expectations may include business benefits or business goals that motivate implementation of the process or targeted aspect of the process, and may further include assumptions on which the relevant process aspect implementation or redesign might be based. The business benefits may include hard benefits related to tangible measures which the process aspect implementation or redesign aims to improve, and may also include soft benefits related to intangible measures that are expected to improve due to implementation of the targeted aspect or the process redesign. Hard benefits may for example be a reduction in SLA violation for a particular process or activity, while soft benefits may for example include improved user satisfaction. Particular performance measures that are to be monitored with respect to a targeted aspect of the process may also be entered via the business case user interface, for example by specifying particular predefined KPIs which are to be monitored to assess whether or not the expected benefits or the business case associated with the target aspect is realized in practice. Baseline targets may likewise be provided for respective benefit indicators, as well as threshold values which are to trigger business case alerts. At least some of the threshold values may be associated with corresponding baseline targets, to trigger business case alerts when a respective benefit indicator diverges from the associated baseline target by a value which exceeds a corresponding threshold value. Other threshold values may be provided separately from associated baseline targets, to trigger business case alerts when the threshold values for corresponding benefit indicators are exceeded.

The business case capture system 320 may further include an updating engine 328 to automatically include a business case definition in the business process model responsive to provision of the business case criteria via the business case user interface module 324. An example business process model 404 that includes such a business case definition 450 is described in greater specificity with reference to FIG. 4 below. The business case definition 450 may automatically be implemented by the updating engine 328 in process standard notation, such as BPMN, in which logical process model information 408 forming part of the BPM 404 is coded. The business case capture system 320 thus provides the user with the functionality of including a business case definition 450 in the BPM 404 in process standard notation without requiring the user to directly edit the BPM 404 in process standard notation. Instead, the user may conveniently enter the business case criteria in a custom business case user interface and the business case definition 450 is automatically included in the BPM 404 by the updating engine 328.

In example embodiments in which business case tracking is performed without use of a BPM engine, or where the targeted aspect of the business process falls outside of the BPM engine's control, the updating engine 328 may serve to update the business case tracking system in accordance with the user-provided criteria, without updating an associated business process model. The updating engine 328 may in such cases automatically update the IT system 240 to generate event alerts relevant to respective benefit indicators responsive to the occurrence of specific events at the IT system elements, and may, in addition, update a business case tracking engine or business case tracking module 352 that is to receive the event alerts and correlate them to the defined business case.

In this example embodiment, a BPM engine 332 may be provided to monitor and manage performance of process activities defined in the BPM 404. The BPM engine 332 may include a data gathering module 336 to gather and collate information regarding the performance of respective processes and/or activities. To this end, the data gathering module 336 may cooperate with monitoring applications (not shown) installed in at least some of the process servers 242, 244 and/or client machines (not shown) forming part of the IT system 240. The BPM engine 332 may thus gather and record information regarding activities performed by respective elements forming part of the IT system 240. The BPM engine 332 may further include a process correlation module 340 to collate or correlate data gathered by the data gathering module 336 with the BPM 404, thereby automatically to measure predefined KPIs, SLAs, and benefit indicators. A case data reporting module 344 may be configured to provide a business case tracking module 352 with real-time or near real-time performance data with respect to multiple process instances or cases. The case data reporting module 344 may, for example, report KPIs for respective cases or process instances, and may further include SLA data indicative of SLA adherence or violation with respect to the business process or a part thereof. The BPM engine 332 may further include an event alert generator 348 to automatically generate and transmit event alerts with respect to the occurrence of certain predefined events to the business case tracking module 352. Such predefined events that trigger event alerts from the event alert generator 348 may be associated with a targeted aspect of the BPM and may be predefined by a user through the use of the business case user interface module 324 as described above.

The business case tracking application(s) 220 may further include the business case tracking module 352 to track realization of the business case associated with the targeted aspect of the BPM 404. The business case tracking module 352 may include a data integration module 356 to receive data with respect to implementation of the relevant targeted aspect of the business process from multiple sources. The data integration module 356 may thus collate performance data from the BPM engine 332, event alerts from IT system elements, and/or survey results, in order to measure the predefined benefit indicators. Particular data elements that are received by the data integration module 356 in accordance with an example embodiment are described in greater detail with reference to FIG. 4 below. The business case tracking module 352 may also include a sampling module 360 to sample information received by the business case tracking module 352, so that the business case tracking is performed based at least in part on sampled data. Such sampling may be time-based or may be in event-based.

A progress report generator 364 may be provided to generate a progress report that indicates the measured benefit indicators relative to the user-defined business case, to provide an indication of realization of the business case. The progress report generator 364 may in one embodiment include a display module 370 to generate a visual display that may provide a unified view or dashboard on which progress of a plurality of benefit indicators relative to respective baseline targets may be displayed. The business case tracking module 352 may yet further include a realization alert module 374 to automatically generate a business case alert when predefined criteria with respect to realization of the business case are satisfied. The business case definition 450 may, for example include threshold values 474 (see FIG. 4) supplied by the user, business ease alerts being generated automatically when these predefined threshold values 474 are exceeded. The realization alert module 374 may, for example, be configured to send business case alerts when assumptions 464 (FIG. 4) forming part of the business case definition 450 are met, when process goals are consistently not being met beyond an associated threshold (so that the BPM is determined to be going out-of-sync), when feedback surveys associated with soft benefits exceed an associated conclusive threshold, and/or when a particular KPI that is a benefit indicator consistently meets associated baseline targets 472 and/or threshold values 474.

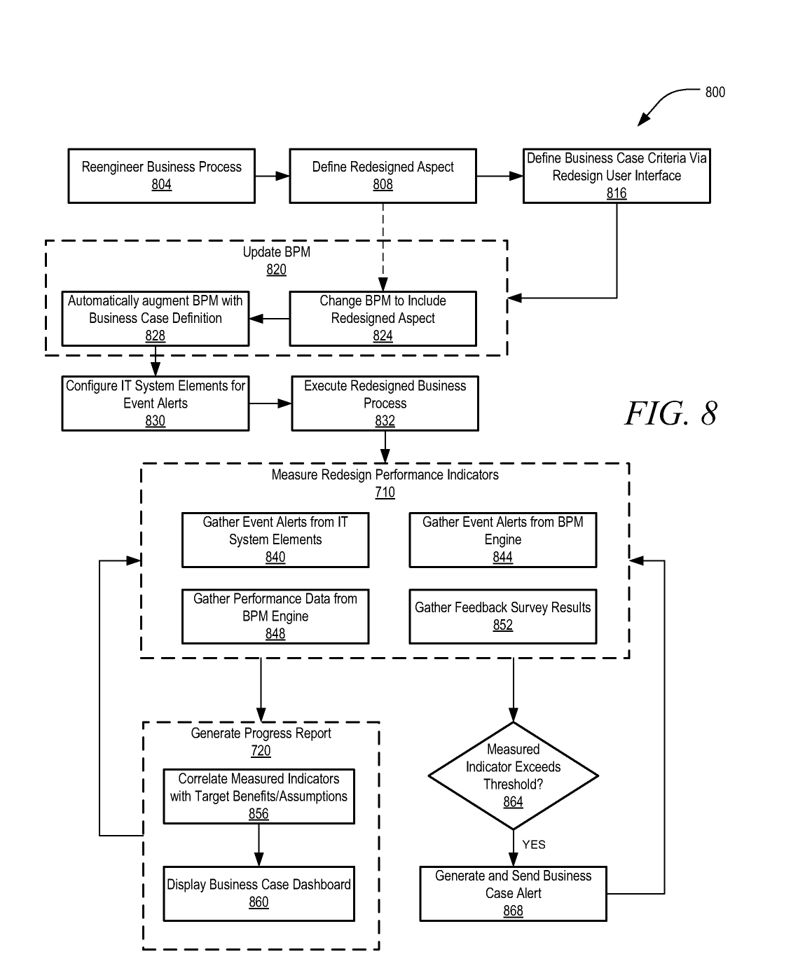

Further functionalities of the business case tracking application(s) 220 are described with reference to an example method set out in FIG. 8 below.

### Data Structures

FIG. 4 is an entity-relationship diagram, illustrating various tables, data repositories, and databases that may be maintained within the databases 226, 228 (FIG. 2), and that may be utilized by the business case tracking application(s) 220. The example embodiment of FIG. 4 is with respect to an embodiment in which business case realization is tracked based at least in part on a BPM. Thus, the databases 226 may include business process model information in the form of a structured BPM 404, in the current example being in process standard notation. The BPM 404 may include logical process model information 408 together with operationalization data in the form of dependency information 412.

The logical process model information 408 includes a logical process model 416 comprising structured data defining the activities or steps constituting the business process, and showing relationships between respective process activities. In the current example, the logical process model 416 may be a logical process model defining the sequence of process activities abstractly, without defining relationship of the activities or processes to process elements associated with operationalization of the process, which may be provided by the dependency information 412.

The logical process model 416 references defined performance measures 420 which may include service-level agreement (SLA) definitions 424 and key performance indicator (KPI) definitions 428. The performance measures 420, SLA definitions 424, and KPI definitions 428 may be user-specified via the rules engine 310. The logical process model 416 may further reference cost information 432 that indicates a cost of respective activities or sub-processes. Such cost may be expressed, for example, in employee-hours, currency, resource load, or the like.

The dependency information 412 may comprise structured information regarding dependencies of respective processes and/or process activities on process elements. The dependency information 412 include IT system dependency information 444 that comprises information regarding process dependency on IT system elements of the IT system 240. The IT system dependency information 444 may thus include information regarding dependency of processes or activities on software such as process applications 246, 248, as well as dependency on IT infrastructure. In this regard, IT infrastructure refers to the configuration and arrangement of hardware forming part of the IT system 240. IT infrastructure information may thus include the properties, status, configuration, and relationships of hardware components such as particular servers, machines, and/or interfaces in the IT system 240. The term IT system includes the IT infrastructure and software or process applications 246, 248 supported by the IT infrastructure.

The dependency information 412 may further include human resources (HR) dependency information 440 in which is stored structured information regarding the dependency of respective processes or process activities on particular HR components, such as people or personnel. The HR dependency information 440 may for example specify the'job role or personnel department responsible for the performance of a particular process activity.

Physical infrastructure dependency information 436 may also be included in the dependency information 412 to indicate the dependency of respective process activities on physical infrastructure components. Such physical infrastructure components may include, for example, vehicles, machinery, supply-chain elements, buildings, and the like. The dependency information 412 may also include data dependency information 432 that may indicate dependency of process activities on data quality and/or data availability.

It will be appreciated that the logical process model information 408 and the dependency information 412 together provide business process model information defining a process architecture for the IT system 240, the process architecture comprising, on the one hand, the processes and activities defined by the logical process model 416, and, on the other hand, information on the operationalization of the processes and activities as defined by the dependency information 412.

As mentioned above with respect to FIG. 3, the logical process model information 408 may further include a structured business case definition 450 that is coded in the native language of the BPM 404. The business case definition 450 may include quantified expectations in the form of quantified business benefits 454 and assumptions 456 that may comprise a business owner's reasons and/or motivations for implementation of a particular BPM aspect or redesign. The assumption(s) 456 may be in the form of quantified expectations with respect to a particular performance measure 420, for example that the costs associated with performance of a particular process or activity will be reduced by a certain quantified amount due to implementation of a redesigned aspect of the business process, or the implementation of a business process is to achieve a defined business goal. The business benefits 454 may include hard benefits 458 and soft benefits 462. The hard benefits 458 are benefits that are tangible or directly measurable by the BPM engine 332, such as a reduction in violation frequency of a particular SLA 424 or improvement in a particular measurable KPI 428. Soft benefits, on the other hand are with respect to intangible measures that can be quantified or assessed only by measuring subjective user or client experience and/or opinion.

The business case definition 450 may thus include a definition of benefit indicators 466 that are to be measured in order to track the business case for the associated process aspect or redesigned aspect redesign in practice. The benefit indicators 466 may be a subset of the performance measures 420 previously defined as part of the logical process model information 408, and may automatically be selected by the updating engine 328 based on the business benefits 454 and the assumptions 456. In other instances, the benefit indicators 466 may be specific to the targeted process aspect and business case definition 450, for example being specified by the user during definition of the business case through the business case capture system 320 (see FIG. 3). In such case, the benefit indicators 466 which are user-specified for business case tracking and may automatically be included in the defined performance measures 420, to provide automated measurement of the benefit indicators 466 via the BPM engine 332 in real-time.

The business case definition 450 may yet further include baseline targets 472 provided by the user for respective benefit indicators 466 or combinations thereof. Threshold values 474 may also be provided (as described above with reference to FIG. 3) to define performance criteria with respect to the benefit indicators 466 which are to trigger business case alerts to report business case satisfaction or divergence to the business owner. As mentioned previously, at least some threshold values 474 may be associated with corresponding baseline targets 472, to automatically trigger business case alerts when the associated benefit indicators diverges from the baseline targets 472 by more than the associated threshold value(s) 474.

As illustrated in FIG. 4, the business case definition 450 may be generated, at least in part, by the updating engine 328, based on user-provided business case criteria. FIG. 4 also illustrates that the updating engine 328 may be used for modifying the logical process model 416 during process redesign. In other embodiments, the logical process model 416 may be manually modified by an operator through use of the model building/editing module 304, while only the business case definition 450 may automatically be inserted, at least in part, in the business process model 404 by the updating engine 328 with respect to, for example, a redesigned aspect of the logical process model 416.

As can also be seen with reference to FIG. 4, the BPM engine 332 may monitor or track performance of respective cases of the business process with reference to the BPM 404. The BPM engine 332 may thus generate and/or maintain performance data 476 with respect to real-world execution of the business process by the IT system 240. To this end, the BPM engine 332 may generate correlation identifiers 478 that uniquely identify respective cases in the business process. The BPM engine 332 may further generate and/or maintain case data 482 with respect to the individual cases or instances of the process. The case data 482 may for example include current progress of the respective cases, incidents or tickets raised in the respective cases, the assignees responsible for execution of particular activities in each case, completion time of each activity/step/process, and the like. The performance data 476 may further comprise SLA data 408 before indicative of actual SLA adherence or violation. The performance data 476 may likewise include KPI data 486 with respect to KPIs 428 that are defined in the logical process model information 408 as performance measures 420 that are to be monitored. The KPI data 486 thus includes the benefit indicators 466 provided as part of the business case definition 450.

The performance data 476 of the BPM engine 332 may further include BPM event alerts 488 that are generated by the BPM engine 332 responsive to the occurrence of particular predefined events during execution of the respective instances of the business process. Although not illustrated in FIG. 4, defined conditions for the automatic generation of a BPM event alert 488 by the BPM engine 332 may be provided as part of the business case definition 450. When the BPM engine 332, during its monitoring of the business process, records satisfaction of the predefined conditions with respect to a particular case, a BPM alert 488 is automatically generated. Such BPM event alerts 488 may automatically be transmitted to the business case tracking module 352, or may be stored by the BPM engine 332 for access by the business case tracking module 352. All or selected items of the performance data 476 may continuously or intermittently be communicated from the BPM engine 332 to the business case tracking module 352.

The business case tracking module 352 may also receive IT event alerts 492 from respective IT system elements, for example by operation of the event reporting modules 270 (see FIG. 2) forming part of the respective IT system elements. Note that some events that are to be monitored as part of the business case tracking functionality provided by the business case tracking system 202 may be registered on an IT system level, without requiring reference to the BPM 404, and that such events may be reported to the business case tracking module 352 by IT event alerts 492 generated by the IT system elements. For example, if an event which is to be monitored as one of the benefit indicators 466 includes the number of incident tickets of a particular type, a process application 246 in the IT system 240 which processes such incident tickets may be arranged automatically to generate an IT event alert 492 whenever it receives an incident ticket of the particular type. Other events that are to be monitored in order to track the business case may, however, be registered or picked up only with reference to the business process model 404, and such events may therefore be reported by way of BPM event alerts 488 generated by the event alert generator 348 forming part of the BPM engine 332. Although not shown in FIG. 4, the updating engine 328 may be configured automatically to update or configure respective IT system elements to generate and send IT event alerts 492 in accordance with the user-provided criteria.

The business case tracking module 332 may further operate to receive survey results 494 associated with soft benefits 462 defined in the business case definition 450.

As can be seen with reference to FIG. 4, the business case tracking module 352 receives or accesses information about actual performance of the business process, and therefore of the targeted aspect of the business process, from the BPM engine 332, the IT event alerts 492, and that the survey results 494. This information is used by the business case tracking module 352 to measure the benefit indicators 466 and to evaluate the measured benefit indicators 466 against the baseline targets 472, the threshold values 474, the quantified business benefits 454, and the quantified assumptions 456 of the business case definition 450 provided as part of the business process model 404.

In other example embodiments, in which at least part of the targeted aspect of the business process is not monitored by a BPM engine, the business case definition 450 may be provided separately from a defined business process model. In such cases, dynamic measurement by the business case tracking module 352 of performance of the targeted aspect of the business process may be based on IT event alerts received from the IT system. A schematic example of such an embodiment is described below with reference to FIG. 6B.

### Example Logical Process Module

The concept of a logical process model 416 described above will now be further explained by way of example with reference to extracts from example GUIs that may be generated by the GUI module 312 according to an example embodiment. In FIG. 5A, reference numeral 500 generally indicates an example graphical representation of a value chain diagram providing an overview of an example business process defined by the business process model 404. The value chain represents the chain of business activities that generate value for an enterprise. The example value chain diagram 500 is with respect to a business which provides credit card services to customers. The value chain diagram 500 represents a highest level of the enterprise model and comprises, at the highest level, a series of organizational units. In this example, the value chain diagram 500 comprises the organizational units of Marketing 502; Customer Services, Operations and Finance/Accounting 504; Credit and Risk Management 506; and Collections 508.

It is to be noted that, at the highest level of the value chain, different enterprises in a particular industry or field of business may be somewhat similar. For example, all computer chip manufacturing firms may have a similar sequence of elements, such as fabrication. However, the enterprise model includes further levels which indicate the organization of a particular enterprise, and in the lower levels there may be great differences between respective enterprises in the same field. The particular organization of an enterprise may be influenced by the scale of operations, the history of the enterprise, and a variety of other factors. For instance, two cable TV companies operating in adjacent markets and offering nearly identical products may be completely different in their organization at lower levels. In other examples, the value chain diagram may decompose the enterprise process, at a high level, according to business domains. In this regard, “business domain” is understood as a particular line of business. For example, in a financial services organization, domains can include Deposits, Loans, Investments, and Insurance. Such domains can be further decomposed into sub-domains. A business domain of Loans can for instance include Corporate and Personal sub-domains.

As illustrated in FIG. 5A, the value chain diagram 500 specifies the functional decomposition of each of the organizational units 502 to 508 in respective series of functions or processes. Thus, for example, the organizational unit of customer services, operations and finance/accounting 504 is comprised of a series of functions or processes. A user can view further organizational details or functional decomposition of each of the functional processes constituting the organizational unit 504, by selecting the associated function or process in the GUI. Organizational units may thus be categorized by the function they perform. It is to be noted that functions may be specific to a business domain/sub-domain, or may be shared across domains/sub-domains. For example, recruiting and other human resource functions may be shared functions, while, for instance, warehouse operations may be specific to a sales and distribution area of a large retailer.

In FIG. 5B, reference numeral 540 generally indicates functional decomposition of the function of Transaction Processing and Management 510, specifying a series of sub-functions which includes Dispute Management 514. The diagram 540 of FIG. 5B is thus a lower-level view of one of the functions forming part of the diagram 500 of FIG. 5A, and it will be appreciated that each of the functions shown in FIG. 5A may similarly be viewed at a lower level.

Likewise, diagram 580 in FIG. 5C shows yet further functional decomposition of the sub-function of Dispute Management 514, which comprises a series of processes forming part of the Dispute Management 514 sub-function. One of these processes is Monthly Billing of Presentments and Re-Presentments 518. A user can select any one of the processes of FIG. 5C, to view a part of the logical process model 416 specifying a series of activities comprising the process, as well as dependency information 412 of the process activities. A GUI representative of part of such an example process model for the process of Monthly Billing of Presentments and Re-Presentments is generally indicated by reference numeral 518 in FIG. 5D. It is to be appreciated that the user may thus drill down to a specific part of the BPM 404, as exemplified by the various levels of the BPM 404 illustrated in FIGS. 5A-5D. The number of levels of the enterprise model may vary depending on the complexity of the enterprise, and may well exceed the limited number shown here.

The process model shown in GUI 518 may include a part of the logical process model 408 indicating a sequence of activities 550-560. Human resource dependency information 440 is indicated in the GUI 518 by location of blocks representing the activities 550-560 in one of a number of bands 522-528. In the example GUI of FIG. 5D, only HR dependency information 440 is shown, but it will be appreciated that other dependency information, such as IT system dependency information 444, physical infrastructure dependency information 436, and data dependency information 432 may also be depicted in other embodiments.

The example process is initiated by an activity to trigger monthly billing 550. This activity is performed automatically by the IT systems, as indicated by its being located in the IT systems band 522. The process further includes the step activity of starting a billing process for each project, at block 552. The next activity in sequence is to fill in details of services performed, at block 554. This activity is to be performed by a project manager, as indicated by location of the block 554 in the project manager band 524. Thereafter, the process comprises the activity of verifying that services are billable according to contract, at block 556. This activity is dependent on the human resource component of the finance team, indicated by reference numeral 526 in FIG. 5D. After verification that services are billable, at block 556, the process model includes an activity for generating an invoice, at block 558. Finally, invoices are submitted to the client, at block 558, by an account manager indicated by the associated band 528 in FIG. 5D. Operations within the bands 522-528 may be entirely automated.

### Flowcharts

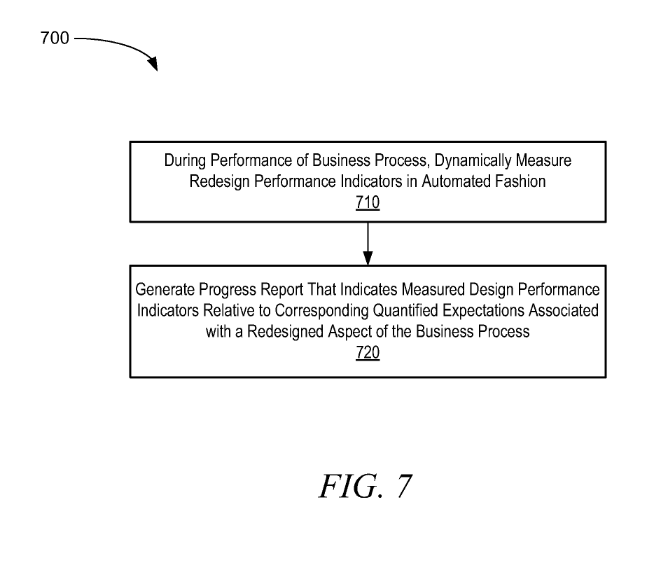

An example method will now be described with reference to FIGS. 6-8. In the current example embodiment, the method described below is performed by the business case tracking system 202 described with reference to FIGS. 2-4 above. Note that the various modules, engines, systems, memories, databases and other elements provided by the example business case tracking system 202 need not necessarily be arranged as illustrated with reference to FIG. 2, but may have any convenient configuration to provide the relevant functionalities. FIG. 6A illustrates a functional schematic diagram of the business case tracking system 202, showing functional cooperation between various components of the business case tracking system 202, and with reference to which flowcharts illustrated in FIGS. 7 and 8 may best be understood.

FIG. 7 shows a high-level flowchart of a method 700 for automated business case tracking. The method comprises dynamically measuring benefit indicators 466 (FIG. 4) during performance of the business process, at operation 710, in an automated fashion. The method 700 further comprises generating a progress report, at operation 720, that indicates a comparison of the measured design performance indicators relative to corresponding quantified expectations (as for example specified in the business case definition 450) that are associated with a targeted aspect of the business process, such as a redesigned aspect of the process.

FIG. 8 shows a more detailed flowchart of a method 800 to track business case realization in an automated fahion. In the example embodiment described with reference to FIG. 8, business case tracking is performed with respect to a redesigned aspect of an existing business process defined by a BPM. It is to be noted that this example embodiment is intended to be nonlimiting, and that, for example, other embodiments may provide business case tracking with respect to processes or aspects of processes that do not constitute redesigned aspects, while some embodiments may be implemented without a structured BPM, or with less integration between a structured BPM and the business case tracking system that is described in the example embodiment.

The method 800 commences when business owners perceive a need or desire to improve or change the business process and therefore reengineer the business process, at operation 804. Such process reengineering may comprise the addition of a process or activity, the streamlining of a process by removal or change of certain steps or activities, or implementation of new process elements, such as new IT system elements, to perform particular processes or activities.

In one example embodiment, a business process that includes an internal procurement activity may be subject to a business process reengineering operation to improve the processing and operational efficiency of its procurement process. The reengineering exercise, at operation 804, may include considering various recommendations or options to improve the relevant process and the supporting IT applications involved in procurement. A computation of expected benefits associated with each recommendation may be performed, after which the computed benefits are aggregated and a business case is prepared to justify or motivate changes that are to be made to the relevant IT applications.

In the example embodiment, the targeted aspect of the process that is to be tracked comprises a redesigned aspect of the business process that relates to the generation of indent requisitions, being requisitions to pay for particular company expenditures. The process reengineering may be motivated by difficulties experienced with the aspect of the business process that is to be redesigned, in the present example being that a current design of an Indent Requisition Form is considered difficult to use by many users. It may further be determined that the users are not guided by an associated process application for capital and operational expenditures (e.g. a “CAPEX-OPEX” application) to raise proper indents. Indent requisition activity therefore experiences a large number of refer-backs of indents, possibly indicating that a current user-driven approach and free format data entry methods commonly lead to wrong selections and wrong attributions on the Indent Requisition Form.

A recommendation is thus accepted in the current example to provide an Indent Wizard to guide the user in generating Indent Requisition Forms that match the relevant requirements. Sections of an indent requisition screen, in accordance with the redesigned aspect, are to be loaded dynamically based on selections made by the user. Unnecessary user-driven fields in the current Indent Requisition Form are to be converted to system-driven or pre-loaded fields based on business logic.

Benefits associated with the proposed redesigned aspect of the business process may include minimal user training requirements, a reduction in incorrect contents in Indent Requisition Forms, and the elimination of a refer-back process relating to indent requisition. At least some expected benefits associated with the process redesign may be quantified. For example, a reduction in costs associated with resolution of incorrect Indent Requisition Forms (performed in this example by a so-called Smart Service Desk (SSD)) may be estimated as shown in Table 1 below, based on an assumption that the process redesign will result in a reduction of wrong indents by 90%.

TABLE 1

| | |
|---|---|
| Total no. of indents | 1282 |
| Total No. of Referbacks | 734 |
| Out of Total Referbacks, no. of indents referred back to Indenter | 716 |
| (For wrong indents reasons) | |
| Total No. of Rejections | 98 |
| Total No. of Rejections (For Wrong Indents) | 22 |
| Total No. of Wrong Indents (Referback + Rejections) | 738 |
| % of Wrong indents raised to total No. of Indents | 58% |
| Assuming Wizard Manager can reduce the incidence of | 6% |
| wrong indents by 90%, the % of wrong indents to total no. | |
| of indents, can come down to | |
| Benefits Computation | |
| No. of SSD’s raised attributed to ‘User Unawareness’ reasons | 869 |
| (Period of April 2009 to May 2010) | |
| Total No. of SSDs on Procurement | 4865 |
| % of SSDs attributed to ‘User Awareness’ to Total No. | 18% |
| of SSDs on Procurement | |
| Average No. of Days required to resolve an SSD | 3 |
| Total No. of Man days consumed because of Wrong Indents raised | 2607 |
| Savings using Wizard Manager (SSD’s coming down by 90%) | 86.9 |
| Total No. of Man days consumed because of Wrong Indents raised | 260.7 |
| Effort Savings in Man Days | 2346.3 |

After the business owner settles on a particular redesign, the redesigned aspect is defined, at operation 808, by identifying changes that are to be made to the existing BPM 404 to implement the redesigned aspect of the business process. In some embodiments, the logical process model 416 and/or dependency information 412 (FIG. 4) may be updated manually in accordance with the identified redesigned aspect, at operation 824. An operator 604 (FIG. 6A) may thus at design-time change the logical process model 416 to include the redesigned aspect, in the current example changing the logical process model 416 with respect to the indent requisition process. Such changes to the logical process model 416, associated performance measures 420, and the dependency information 412 may be made by the operator 604 through the use of the model building/editing module 304 (FIG. 3).

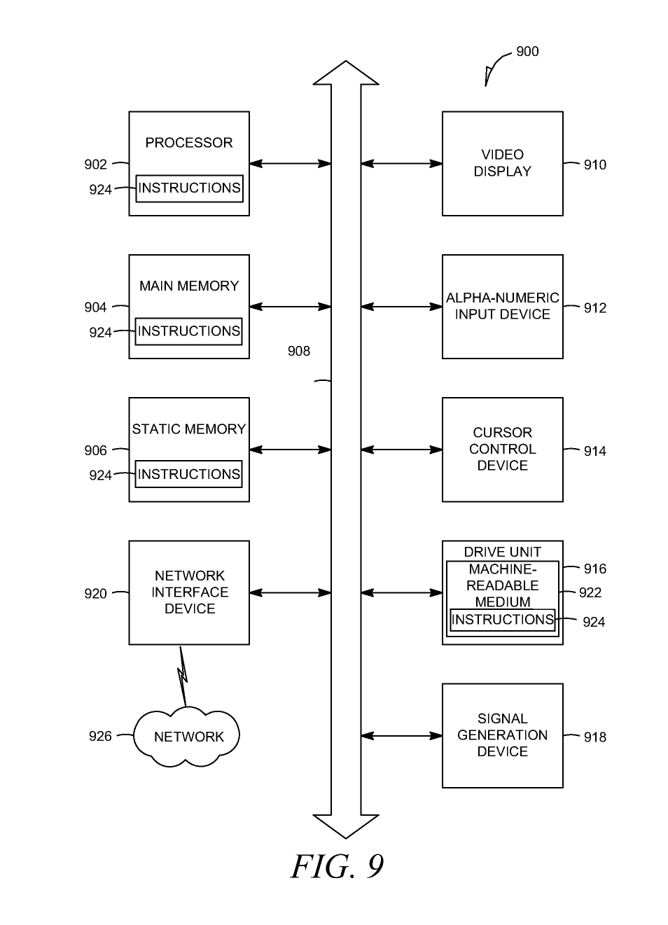

Thereafter, the operator 604 may define the business case, at operation 816. This may comprise inputting business case criteria for the process redesign via a business case user interface 608 (see FIG. 6A) provided by the business case capture system 320. The business case criteria thus provided by the operator 604 may comprise quantified expectations associated with the redesigned aspect, such as expected benefits flowing from implementation of the redesigned aspect or assumptions on which the redesign might be based. The business case criteria may also include particular benefit indicators 466 (FIG. 4) that are to be tracked in order to assess realization of the business case in practice, as well as baseline targets 472 for particular performance measures 420. The operator 604 may optionally also provide threshold values 474 for particular benefit indicators 466, upon which the automatic generation of business case alerts are to be based. Any or all of the data described herein (e.g., data that may be stored in the business case database 228) may be received at the redesign user interface 608, perhaps as signals generated by a user interface device (e.g., keyboard or other device, such as one or more elements 910, 912, 914 in FIG. 9).

In the current example redesign of an indent requisition process, the operator 604 may enter into the business case user interface 608 (which serves as a redesign user interface) an assumption 456 (FIG. 4) of a 90% increase in accuracy of indents raised. A further assumption 456 entered via the business case user interface 608 may be that implementation of the redesigned aspect will effect a 100% improvement in completeness of indent requisition. Associated with these assumptions 456, benefit indicators 466 may be specified to measure the accuracy of indents, and to measure completeness of indent requisition. Associated baseline targets 472 and threshold values 474 may likewise be specified and received based on the above-provided values. A threshold value 474 of 90% increase in indent accuracy may, for example, be specified, so that a business case alert is automatically generated and transmitted to a user 64 (see FIG. 6A) when a 90% increase in indent accuracy is recorded. In a similar fashion, the business case criteria may include business benefits 454 (FIG. 4) that comprise a hard benefit 458 of a 2300 day reduction in employee-days associated with SSD activity for incorrect indent requisitions. Business case criteria thus entered may be stored in the business case database 228 or in one or more memories performing a similar function.

Thereafter, the BPM 404 is updated, at operation 820. As mentioned above, updating the BPM 404 may include manual changes to, for example, the logical process model information 408 and/or the dependency information 412. In some embodiments, at least some changes stemming from the process redesign may automatically be effected in the logical process model information 408 and/or in the dependency information 412 by the updating engine 328 (see also FIG. 6A). For example, new IT system dependency information 444 and/or new KPI definitions 428 may automatically be included in the BPM 404 by the updating engine 328. The updating of the BPM 404, at operation 820, further comprises automatically augmenting the BPM 404 with the business case definition 450, at operation 828. As can be seen with reference to FIG. 4, the business case definition 450 comprises the various business case criteria received via the business case user interface 608, and is automatically inserted by the updating engine 328 in the BPM 404 in the native language of the BPM 404. In the current example embodiment, the business case definition 450 is provided as an extension, or augmentation of process standard notation, having respective fields for at least the data elements illustrated in FIG. 4 as forming part of the business case definition 450. Configuration of the business case tracking system 202 to track a specific business case and to provide reliable proactive progress reports and/or alerts can thus conveniently be done by entering the business case criteria in the business case user interface 608 and does not require an operator 604 to code the business case in process standard notation.

Relevant IT system elements 246-248 (see FIG. 6A) may thereafter be configured, at operation 830, to provide IT event alerts 492 responsive to the occurrence of respective defined events. With reference to the example redesign of an indent requisition process, as set out above, a requisition processing application 247 may be configured to generate and send an event alert 492 whenever it records a refer-back due to an incomplete indent or due to missing information. In this example, configuration of the IT system elements 246-248 to generate and transmit the IT event alerts 492 is performed automatically by the updating engine 328. The requisition processing application 247 as, for example, configured to automatically report any submission of an incorrect Indent Requisition Form, which is relevant to the associated benefit indicator 466. A Smart Service Desk (SSD) system 248 could likewise be configured to send IT event alerts 492 in case any incident ticket relating to an indent requisition form is raised which is categorized as being user-awareness related. Such IT event alerts 492 may be transmitted to a business case tracking engine 612 (see FIG. 6A) provided by the business case tracking module 352 described with reference to FIG. 3. The IT system elements 246-248 may be configured to produce the IT event alerts 492 in a predefined standard format or scheme. Such a standard scheme or format may include information regarding particular benefit indicators 466 to which individual IT event alerts 492 pertain.

Thereafter, the redesigned business process, which includes the implemented redesigned aspect, may be executed, at operation 832. Such business process execution may comprise real-world performance of multiple cases or instances.

The method 800 thereafter comprises monitoring the redesigned business aspect to measure the benefit indicators, at operation 710, in order to track the business case associated with the process redesign. Monitoring of the business case may be performed by the business case tracking engine 612, which may collate or gather business case-related information from various sources forming part of the business case tracking system 202. The business case tracking may thus include gathering or receiving event alerts 492 from IT system elements 246-248, at operation 840.

BPM event alerts 488 may likewise be received or gathered from the BPM engine 332, at operation 844. In some embodiments, the relevant benefit indicators 466 may include one or more performance measures for which individual events cannot readily be noted or registered at IT system application-level, and such events may thus be reported to the business case tracking engine 612 by the BPM engine 332 in respective BPM event alerts 488. SLA violations, for example, may in some instances be noticeable only on a business process management-level. Such BPM event alerts 488 may, in a fashion similar to the IT event alerts 492 described above, be published in a standardized format or scheme for convenient processing by the business case tracking engine 612.

The business case tracking engine 612 may further gather or receive performance data 476 from the BPM engine 332, at operation 848 (see also FIG. 6A). As can be seen with reference to FIG. 4, the performance data 476 reported to the business case tracking engine 612 may include correlation identifiers 478 of individual process instances, individual or statistical case data 482, individual or statistical SLA data 484, and individual or statistical KPI data 486. It is to be noted that the particular performance data 476 that is reported by the BPM engine 332 to the business case tracking engine 612 may comprise a subset of all the performance data gathered by the BPM engine 332, the particular performance data 476 to be reported being automatically or manually determined according to the business case definition 450 in general, and according to the benefit indicators 466 in particular.

In some embodiments, the business case tracking engine 612 may continuously receive the above-described information, and may base further operations, such as the generation of progress reports or business case alerts, on all of the measurement information it receives. In other embodiments, the business case tracking engine 612 may employ sampling of the event alerts 488, 492 and performance data 476 that it receives. Such sampling may be time-based, in that the taking of a sample comprises considering all relevant alerts and/or data received or occurring within a particular sample window. Instead, the sampling may be event-based, in that a random subset of events and/or data for a certain period is considered.

Survey results 494 may further be gathered or received by the business case tracking engine 612, at operation 852. These survey results 494 may be results of feedback surveys 616 (see FIG. 6A) completed by users and/or clients with respect to soft benefits 462 defined in the business case definition 450. Feedback surveys 616 may, for example, be provided to employees responsible for generating Indent Requisition Forms, to gauge user satisfaction and/or subjective ease-of-use of the redesigned indent requisition process. A quantified improvement or value for such user satisfaction may be defined as one of the soft benefits 462, so that the results of the feedback surveys 616 may serve to measure an associated benefit indicator 466.

The business case tracking engine 612 may generate progress reports, at operation 720, based on the real-time measurement performed at operation 710. The business case tracking engine 612 may thus correlate or compare, at operation 856, the measured benefit indicators 466 with the business benefits 454, assumptions 456, baseline targets 472, and/or threshold values 474 provided as part of the business case definition 450. The progress report may in one embodiment be a business case dashboard 620 (see FIG. 6A) displayed to a business case owner or user 624, at operation 860. The business case dashboard 620 may comprise a visual display providing visual or textual indication of at or near real-time values for the benefit indicators relative to corresponding values of the business case. A graph may for example be provided that shows progress over time of an improvement in the percentage of Indent Requisition Forms that are referred back or rejected. The same business case dashboard 620 may at the same time display a currently measured percentage reduction in incomplete or incorrect Indent Requisition Forms, against the associated expected 100% reduction baseline target, and may also display current progression of a measured reduction in employee-hours associated with indent requisition problem resolution at the Smart Service Desk, compared to an expected progression based on the 2300 hour expected reduction included in the business case definition 450.

The business case tracking engine 612 may further continuously determine, at operation 864 whether or not measured benefit indicators 466 meet or exceed corresponding threshold values 474, and may automatically generate and send a business case alert, at operation 868, if the determination is in the affirmative. One of the threshold values 474 in the current example may for instance be specified such that an electronic alert, such as an e-mail or SMS, is automatically sent to a receiving device (e.g., a terminal having a display 910 in FIG. 9) to be viewed by the business case owner 624 when the expected 2300 hour reduction in SSD employee-hours is achieved.

FIG. 6B shows a schematic illustration of another example embodiment of a business case tracking system 650. The business case tracking system 650 of FIG. 6B is similar to the system described with reference to FIG. 6A, with like elements being indicated by like reference numerals. A distinction, however, between the example embodiments of FIG. 6A and FIG. 6B is that the business case tracking system 650 of FIG. 6B does not include a BPM engine 332 to monitor performance of a targeted aspect of the business process with respect to a structured business process model. The updating engine 328 therefore does not automatically update the business process model and/or the BPM engine, while the business case tracking engine 612 does not receive BPM event alerts 488 and performance data 476 from the BPM engine 332.

Instead, the business case tracking engine 612 of the system 650 performs business case tracking based on IT event alerts 492 received from the respective IT system elements 246-248, and/or on feedback surveys 616. The business case tracking engine 612 correlates the information it receives from the IT system 240 and the feedback surveys 616 to the relevant business case definition, and generates the business case dashboard 620, business case alerts, and the like in a manner similar to that described with reference to FIG. 6A. The updating engine 328 may be configured automatically to update the IT system 214, the business case tracking engine 612 and/or a business case definition stored in the business case database 228 responsive to receiving business case criteria from the operator 604 via the business case user interface 608.

It is a benefit of the above-exemplified methods and systems that they provide for automatic and proactive business case tracking to alert or inform business owners as to whether or not a business case associated with a targeted business process, business process aspect, or process redesign is being realized in practice. Such proactive provision of business case realization information may assist the business owner in early detection of implementation of an unsuccessful process aspect, or unsuccessful process redesign, and may facilitate effective second wave process engineering. Business case alerts may also be configured in some instances to alert business case owner is when a particular business process or a particular business process aspect has realized or completed the purpose for which it was implemented, to facilitate timely termination of unnecessary or redundant business processes or business process aspects.

Embodiments that employ business case tracking with respect to process aspects that are not monitored by a BPM engine (such as that described with reference to FIG. 6B) have the benefit of allowing the tracking of particular benefit indicators, and associated business cases, without the need for explicit process modeling and process monitoring by a BPM engine.

FIG. 9 shows a diagrammatic representation of machine in the example form of a computer system 900 within which a set of instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a server computer, a client computer, a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 900 includes a processor 902 (e.g., a central processing unit (CPU) a graphics processing unit (GPU) or both), a main memory 904 and a static memory 906, which communicate with each other via a bus 908. The computer system 900 may further include a video display unit 910 (e.g., a liquid crystal display (LCD) or a cathode ray tube (CRT)). The computer system 900 also includes an alphanumeric input device 912 (e.g., a keyboard), a cursor control device 914 (e.g., a mouse), a disk drive unit 916, a signal generation device 918 (e.g., a speaker) and a network interface device 920.

The disk drive unit 916 includes a machine-readable medium 922 on which is stored one or more sets of instructions (e.g., software 924) embodying any one or more of the methodologies or function's described herein. The software 924 may also reside, completely or at least partially, within the main memory 904 and/or within the processor 902 during execution thereof by the computer system 900, the main memory 904 and the processor 902 also constituting machine-readable media.

The software 924 may further be transmitted or received over a network 926 via the network interface device 920.

While the machine-readable medium 922 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present invention. The term “machine-readable medium” shall accordingly be taken to include, but not be limited to, solid-state memories, optical and magnetic media, and carrier wave signals.

### Modules, Components, and Logic

Certain embodiments are described herein as including logic or a number of components, modules, or mechanisms. Modules may constitute either software modules (e.g., code embodied (1) on a non-transitory machine-readable medium or (2) in a transmission signal) or hardware-implemented modules. A hardware-implemented module is a tangible unit capable of performing certain operations and may be configured or arranged in a certain manner. In example embodiments, one or more computer systems (e.g., a standalone, client or server computer system) or one or more processors may be configured by software (e.g., an application or application portion) as a hardware-implemented module that operates to perform certain operations as described herein.

In various embodiments, a hardware-implemented module may be implemented mechanically or electronically. For example, a hardware-implemented module may comprise dedicated circuitry or logic that is permanently configured (e.g., as a special-purpose processor, such as a field programmable gate array (FPGA) or an application-specific integrated circuit (ASIC)) to perform certain operations. A hardware-implemented module may also comprise programmable logic or circuitry (e.g., as encompassed within a general-purpose processor or other programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations.

Accordingly, the term “hardware-implemented module” should be understood to encompass a tangible entity, be that an entity that is physically constructed, permanently configured (e.g., hardwired) or temporarily or transitorily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a general-purpose processor configured using software, the general-purpose processor may be configured as respective different hardware-implemented modules at different times. Software may accordingly configure a processor, for example, to constitute a particular hardware-implemented module at one instance of time and to constitute a different hardware-implemented module at a different instance of time.

Hardware-implemented modules can provide information to, and receive information from, other hardware-implemented modules. Accordingly, the described hardware-implemented modules may be regarded as being communicatively coupled. Where multiple of such hardware-implemented modules exist contemporaneously, communications may be achieved through signal transmission (e.g., over appropriate circuits and buses) that connect the hardware-implemented modules. In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation, and store the output of that operation in a memory device to which it is communicatively coupled. A further hardware-implemented module may then, at a later time, access the memory device to retrieve and process the stored output. Hardware-implemented modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., Application Program Interfaces (APIs).)

Thus, a method and system to facilitate process redesign and perform automated business case are disclosed. Although these methods and systems have been described with reference to specific example embodiments, it will be evident that various modifications and changes may be made to these embodiments without departing from the broader spirit and scope thereof. Accordingly, the specification and drawings are to be regarded in an illustrative rather than a restrictive sense.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

What is claimed is:

1. A system comprising:
a hardware-implemented business case tracking module to:
dynamically measure one or more benefit indicators for a business process in an automated fashion during performance of the business process, and
access one or more memories storing a business case definition that includes one or more quantified expectations with respect to implementation of the business process or an aspect thereof; and
a progress report generator to generate a progress report that indicates at least one value permitting comparison between the one or more measured benefit indicators and the one or more corresponding quantified expectations.

2. The system of claim 1, wherein the business case definition is with respect to implementation of a redesigned aspect of the business process.

3. The system of claim 1, further comprising at least one event reporting module forming part of respective IT system elements to communicate event alerts to the business case tracking module, each event alert indicating occurrence of an event that is associated with a particular benefit indicator.

4. The system of claim 3, further comprising an updating engine to receive user input with respect to definition of the one or more benefit indicators, and to automatically configure the at least one event reporting module forming part of the respective IT system elements to generate the event alerts responsive to the occurrence of the associated events.

5. The system of claim 3, wherein process operations performed by at least one of the IT system elements are not monitored by a business process model (BPM) engine that correlates performance of the operations to a business process model.

6. The system of claim 3, wherein the business case tracking module includes a sampling module to capture a sample of event alerts.

7. The system of claim 6, wherein the sampling module is configured to capture the sample of event alerts by taking a random sample from event alerts received within a time period.

8. The system of claim 2, further comprising a business process model (BPM) engine wherein measuring the one or more benefit indicators comprises receiving performance data relevant to the one or more benefit indicators from a business process management engine (BPM) engine that correlates performance of current instances of the business process with a business process model that defines a series of activities comprising the business process, the business case definition being incorporated into the business process model, and the business case definition comprising the one or more quantified expectations and/or the one or more benefit indicators.

9. The system of claim 8, further comprising:
a business case user interface module to provide a business case user interface and to receive via the business case user interface user input with respect to the at least one quantified expectation and/or at least one benefit indicator; and
a BPM updating engine to automatically update the business process model to include the at least one quantified expectation and/or the at least one benefit indicator provided by a user input device coupled to the user interface.

10. The system of claim 9, wherein the BPM updating engine is configured to include in the business case definition at least one associated target value of a particular benefit indicator, a corresponding quantified expectation being realized when a measured value of the particular benefit indicator exceeds the associated target value.

11. The system of claim 1, wherein the business case tracking module comprises a survey integration module to receive results of feedback surveys that indicate a performance measure associated with one of the benefit indicators.

12. The system of claim 1, wherein generating the progress report generator comprises a display module to generate a display of one or more images by which a current status of multiple benefit indicators are shown relative to corresponding quantified expectations.

13. The system of claim 1, further comprising a realization alert module to automatically generate a business case alert responsive to the occurrence of predefined criteria with respect to correlation between a particular benefit indicator and an associated quantified expectation.

14. A method comprising:
during performance of a business process, dynamically measuring one or more benefit indicators associated with the business process in an automated fashion;
accessing a business case definition that includes one or more quantified expectations with respect to implementation of the business process or an aspect thereof; and
generating a progress report that indicates at least one value permitting comparison between the one or more measured benefit indicators and the one or more corresponding quantified expectations.

15. The method of claim 14, wherein the business case definition is with respect to implementation of a redesigned aspect of the business process, the one or more benefit indicators being associated with the redesigned aspect.

16. The method of claim 14, wherein measuring the one or more benefit indicators comprises receiving event alerts from one or more information technology (IT) system elements that form part of an IT system by which at least part of the business process is performed, each event alert indicating occurrence of an event that is associated with a particular benefit indicator.

17. The method of claim 16, further comprising automatically configuring the one or more IT system elements to generate the event alerts responsive to the occurrence of the associated it events.

18. The method of claim 17, wherein automatic configuration of the one or IT system elements is responsive to receiving user input with respect to the particular benefit indicators that are to be measured in order to track business case realization.

19. The method of claim 16, wherein at least some process activities performed by the one or more IT system elements, and with respect to which the event alerts are generated, are not monitored or managed by a BPM engine that correlates performance of the activities to a business process model.

20. The method of claim 16, wherein measuring the one or more benefit indicators may compromise capturing a sample of event alerts.

21. The method of claim 20, wherein capturing the sample of event alerts comprises taking a random sample from event alerts received within a time period.

22. The method of claim 14, wherein measuring the one or more benefit indicators comprises receiving performance data relevant to the one or more benefit indicators from a business process model (BPM) engine that correlates performance of current instances of the business process with a business process model that defines a series of activities comprising the business process.

23. The method of claim 14, further compromising incorporating the business case definition in the business process model, the business case definition comprising the one or more quantified expectations and/or the one or more benefit indicators.

24. The method of claim 23, further comprising:
providing a business case user interface;
receiving via the business case user interface user input with respect to the at least one quantified expectation and/or at least one benefit indicator; and
automatically updating the business process model to include the at least one quantified expectation and/or the at least one benefit indicator provided by a user input device coupled to the user interface.

25. The method of claim 24, further comprising receiving user input with respect to definition of a target value of a particular benefit indicator, a corresponding quantified expectation being realized when a measured value of the particular benefit indicator exceeds the associated target value.

26. The method of claim 14, wherein measuring the one or more benefit indicators comprises receiving results of feedback surveys that indicate a performance measure associated with one of the benefit indicators.

27. The method of claim 14, wherein generating the progress report comprises generating a display that includes one or more images by which a current status of multiple benefit indicators are shown relative to corresponding quantified expectations.

28. The method of claim 14, further comprising automatically generating a business case alert responsive to the occurrence of predefined criteria with respect to correlation between a particular benefit indicator and an associated quantified expectation.

29. A non-transitory machine-readable storage medium storing instructions which, when performed by a machine, cause the machine to:
dynamically measure one or more benefit indicators for a business process in an automated fashion during performance of the business process;
access a business case definition that includes one or more quantified expectations with respect to implementation of the business process or an aspect thereof; and
generate a progress report that indicates at least one value permitting comparison between the one or more measured benefit indicators and the one or more corresponding quantified expectations.

30. A system comprising:
means for dynamically measuring one or more benefit indicators for a business process in an automated fashion during performance of the business process;
means for accessing a business case definition that includes one or more quantified expectations with respect to implementation of the business process or an aspect thereof; and
means for generating a progress report that indicates at least one value permitting comparison between the one or more measured benefit indicators and the one or more corresponding quantified expectations.
